(19) United States
(12) Patent Application Publication
(10) Pub. No.: US 2009/0165594 A1
(43) Pub. Date: Jul. 2, 2009

(54) Controlled vehicular thrust produced by controlled non-uniform acceleration of a liquid

(76) Inventor: Randall Paul Joseph Ethier, Burke, VA (US)

Correspondence Address: Randall Paul Joseph Ethier, 5007 Prince Caspian Lane, Burke, VA, 22015, US

(21) Appl. No.: 12/004,994

(22) Filed: Dec. 26, 2007

(51) Int. Cl. F03G 3/00; F03B 5/00

(52) U.S. Cl. 74/84 R; 415/90

(57) ABSTRACT

A fluidic propulsion system providing controlled vehicular thrust produced by non-uniform acceleration of liquid within annular tubular containers attached to a vehicle.

### BACKGROUND OF THE INVENTION

1) Field of the Invention

The field of the invention is related to an apparatus and method for providing vehicular motion without reaction with the surrounding environment.

2) Description of Related Art

In the context of the field of the invention there are various associated technologies that make use of inertial drives, impulse engines, centrifugal/centripetal propulsion, momentum transfer, motion rectifiers, non-linear propulsion, translational force generators, gyroscopic propulsion, directional force generators, force transducers, magnetohydrodynamic propulsion, and reaction motors that convert rotary motion to linear motion that neither push against the environment outside the vehicle nor expel reaction mass with momentum to achieve forces resulting in transport in the desired direction.

All suffer from one or more of the following problems: intermittent motion, mechanical complexity, technological complexity, or significant inefficiency.

### BRIEF DESCRIPTION OF THE SEVERAL VIEWS OF THE DRAWING(S)

FIG. 1 is a block diagram that illustrates a thrust element according to a first embodiment of the invention.

FIG. 2 is a block diagram that illustrates a thrust element according to a second embodiment of the invention.

FIG. 3 is a block diagram that shows the net force vector resulting from the summation of the sample acceleration vectors from FIG. 2.

### DETAILED DESCRIPTION OF THE INVENTION

An understanding of the invention requires a basic understanding of two well-known laws and two forces from classical mechanics:
1. Newton's 1^{st} law of motion: a body at rest remains at rest and a body in motion travels along a straight line unless acted upon by an outside force. Another way to state it is that the velocity of a body remains constant until acted upon by an outside force.
2. Newton's 3^{rd} law of motion: for every action there is an equal and opposite reaction.
3. Centripetal force: the force that keeps an object moving in a circular path. It is directed inward towards the center of rotation. A string exerts centripetal force on an object when it is used to whirl the object around a circular path. Note that the centripetal force acts only on the body being whirled about the circular path. When the Earth orbits the Sun, the centripetal force is the gravitational pull of the Sun. In classical physics, the magnitude of the force is the mass of the object being whirled times its velocity squared divided by the radius of its path. If m is the mass of the object, v is the velocity of the object, and r is the radius of the circular path taken by the object and if f is the centripetal force then f=mv²/r.
4. Centrifugal force: the opposite reaction force to centripetal force. An object exerts centrifugal force on a string when the string is used to whirl the object around a circular path. Note that the centrifugal force acts only on the source of the centripetal force.

The following are definitions used in the remaining portion of this detailed description of the invention.

Pump: the source of the kinetic energy.

Tube: the source of the centripetal force (like the string).

Non-uniform: Because a liquid follows a closed curved path of varying cross sectional area of an annular tubular container, according to an embodiment, both the direction and the magnitude of acceleration of each liquid particle is constantly changing along its path within the annular tubular container.

Functional unit: the pump, the liquid to be circulated, and the annular tubular container.

Vehicle: a mechanism that transports people or cargo from one point to another point. In this invention the vehicle contains at least one functional unit. When the vehicle operates inside a fluid body or in the vacuum of space, at least two functional units are desirable.

Centrifugal force vectors: In the invention at each point in time a centrifugal force vector corresponding to each liquid particle of the circulating liquid applies to the annular tubular container.

The invention produces controlled non-uniform acceleration of a liquid along an annular tubular container within a vehicle. The end result is an imbalance of centrifugal force. This imbalance provides the thrust for the vehicle.

A theoretical explanation for the effect is given next for purposes of description. However, the invention is not limited by this theory and embodiments may be used even if the theoretical description below is incomplete or otherwise in error.

An intuitive feel for the invention may be obtained by considering a hand held coiled garden hose, more or less parallel with a single plane, with the water turned on. The coiled hose can be easily moved up and down and right and left as long as its new plane is parallel to its previous plane. When twisting the coiled hose such that its new plane is not parallel to its previous plane, the making of this change produces a resistance. As the flowing water circulates in the coiled hose, it undergoes centripetal force and the coiled hose undergoes centrifugal force. As long as the hand held coiled hose is not moving or as long as the plane of the coiled hose remains parallel to its previous plane, the centrifugal force is not discernable; but when the coiled hose's plane is tilted, its centrifugal force may be discerned.

The specific area of orbital mechanics within classical physics can also help to illustrate the mechanics of the invention. When a satellite orbits the Earth, the satellite is undergoing constant acceleration. If the satellite's orbit is circular, the magnitude of the acceleration is constant but its direction is constantly changing. If thrust is added to the satellite in the direction of its orbit around the Earth, the satellite will move to a higher orbit. If thrust is added to the satellite in direction opposite to that of its orbit around the Earth, the satellite will move to a lower orbit.

The invention adds “thrust” to an object orbiting a fixed point (in this case liquid circulating within an annular tubular container attached to a vehicle) and the object (the liquid) wants to move to a higher “orbit”. But the vehicle's annular tubular container presents a barrier to the object. This barrier is part of the vehicle. The object (liquid) pushes against this barrier in its bid to achieve a higher “orbit” and by doing so pushes the vehicle. Another way to describe the object's (liquid's) thrust is to refer to it as the application of centripetal force.

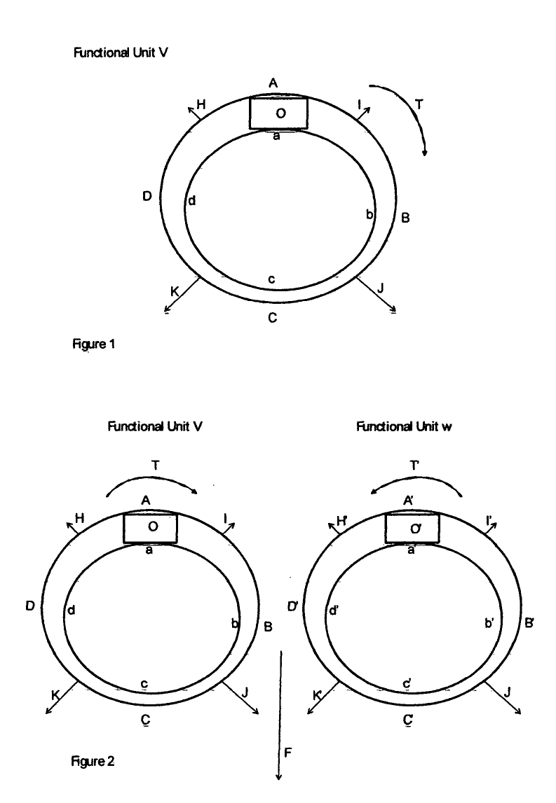

A more analytical way to view the imbalance resulting in vehicular motion is to recall that the magnitude of the centrifugal force (and centripetal) force is mv²/r. In FIG. 1 a liquid is circulated by pump O (e.g. pump) in the direction T along the annular tubular container marked by points a, b, c, d, A, B, C, and D. Note that the annular tubular container is completely filled by the liquid. At any point in time the number of liquid particles passing at all points along the annular tubular container is a constant (assuming an incompressible fluid), but for the segment with a smaller cross sectional area the liquid particles are moving at a higher rate relative to the segment with a larger cross sectional area where the liquid particles are moving at a relatively slower rate. So, along that path of the annular tubular container, the velocity of individual liquid particles varies as does the associated centripetal force of these particles. Where the annular tubular container is relatively narrow, the centripetal force on the liquid will be relatively high. The annular tubular container in FIG. 1 is narrowest along the arcs BCD and bed. Between these two arcs the liquid particles are moving at a higher velocity relative to the liquid particles moving between the arcs DAB and dab. From point A to point C along the annular tubular container in the rotational direction of T, the liquid particles move such that the magnitude of the centrifugal force vectors increases. The maximum magnitude of centrifugal force is at the cross sectional area bounded by the points C and c. Note that the summed magnitudes of the centrifugal force vectors along the annular tubular container's arc BCD are larger than the summed magnitudes of the centrifugal force vectors along the annular tubular container's arc DAB. The summation of all of the concurrent centrifugal force vectors is the vehicle's thrust. The four sample-points H, I, J, and K are illustrated centrifugal force vectors of the liquid. Note that out of these 4 sample centrifugal force vectors, J and K have a greater magnitude than H and I.

Also note that while the vehicle is undergoing acceleration, the acceleration of the liquid particles is slightly skewed by the said acceleration of the vehicle. For instance, as the vehicle moves “forward”, the liquid particles moving “forward” would have a little less “push” against the annular tubular container in the forward direction. Likewise as the vehicle moves “forward”, the liquid particles moving “backward” would have a little more “push” in the backward direction against the annular tubular container. Note that the absolute displacement of the annular tubular container is significantly less than the absolute displacement of the individual liquid particles and so this impact is relatively small.

If and when a vehicle is in the vacuum of space or when suspended in a fluid, the circulating liquid would not only move the vehicle but it would also cause the vehicle to spin in the opposite direction per Newton's 3^{rd} Law. This spin can be eliminated and this elimination will be explained next. Note that on the surface of a solid or for a floating vehicle on a liquid body, the vehicle's spin would be countered by the surface of the solid or the liquid body.

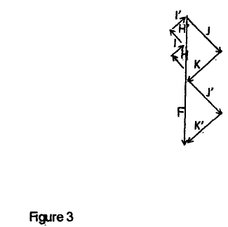

Two functional units may be paired together as shown in FIG. 2. The two functional units are identical except that they are mirror images of each other. The two annular tubular containers of the paired functional units will lie in the same plane. In one, annular tubular container the liquid circulates in a clockwise direction whereas in the other annular tubular container the liquid circulates in a counterclockwise direction. Both liquids undergo identical non-uniform circular acceleration but in opposite directions. Since each functional unit tends to spin the vehicle in an opposite direction, one functional unit cancels out the spin effect of the other functional unit. The summation of the sample centrifugal force vectors H, I, J, K, H′, I′, J′, K′ is the net force vector F shown in FIG. 3.

Note that the invention will be more efficient when utilizing an incompressible liquid relative to a compressible liquid.

Another factor not yet mentioned is the summation of the forces of precession associated with the circulating liquid particles. These forces are negligible and in the paired functional units, they will be canceling each other out. The internal workings of the operating pump may also produce one or more unwanted forces. Again in the paired functional unit, these unwanted forces will cancel each other out.

One way to obtain six degrees of movement is for the vehicle to have six pairs of functional units. For an example in a three dimensional coordinate system x, y, and z where each angle is 90 degrees then two paired functional units will lie in the xy plane, two paired functional units in the yz plane, and two paired functional units in the xz plane.

Note that the turning of the vehicle in intended directions can also be enabled by the controlled use of the spin effect of a given functional unit; for instance, one functional unit within a pair can be temporarily idled until the vehicle's attitude has changed. This can be used to achieve pitch, yaw and roll.

The propulsive force is completely self-contained within the vehicle unlike a car, boat, submarine, airplane, or rocket. In a car the wheels, at least one of which is rotated by the engine by way of its transmission system, forcibly pushes against the ground to propel the car. In a sail boat the wind pushes against a sail connected to the boat. In a motorboat and in a submarine a propeller pushes back on the water to push the boat in the opposite direction. In an airplane the propeller pushes back the air to push the airplane in the opposite direction. In a jet plane and in a rocket a hot gas derived through the burning of propellant is emitted at high speed from an opening; this emission of gas particles in turn pushes the jet plane or rocket in the opposite direction. In an ionic engine very small particles are emitted at very high speed; this emission of particles in turn pushes the vehicle in the opposite direction.

Assuming the pump can operate in the vehicle's environment or that the vehicle brings along environmental resource(s) necessary for the pump's operation, for instance a nuclear power plant for generating electricity or oxygen for burning combustible fuel, then the vehicle can operate in one or more of the following environments:
1. on the surface of a solid object
2. on top of a liquid body residing on the surface of an object such as a planet (such as water bodies on the Earth)
3. through a fluid (gas or liquid) held by a celestial body (such as the atmosphere and the water bodies of the Earth)
4. the vacuum of space

In other words this invention can be used to propel a vehicle that can behave as including but not limited to a car, boat, submarine, aircraft, and/or spacecraft.

In the case of a spacecraft, if it has the ability to produce electricity for a long period of time, perhaps by way of a thermocouple where one end is exposed to a radioactive heat source, then this invention enables a spacecraft over a period of time to achieve a very high velocity. The acceleration of the spacecraft does not require propellant or fuel other than the “fuel” for the generation of the electricity to power the pump. Naturally radioactive materials, fissionable material, and fusible material can serve as long term fuel for the generation of electricity required to power the source of the centripetal force (e.g. an electrically powered pump).

The embodiments of the present invention recited herein are intended to be merely exemplary and those skilled in the art will be able to make numerous variations and modifications to it without departing from the spirit of the present invention. All such variations and modifications are intended to be within the scope of the present invention as defined by the claims appended hereto.

1. An apparatus that is attachable to a vehicle for producing vehicular motion comprising a first functional unit comprising:
An annular tubular container having a varying cross-sectional area along the circumference of said container;
A fluid filling said container;
A pump for circulating said fluid in said container, wherein circulation of said fluid by said pump creates thrust to produce vehicular motion.

2. The apparatus of claim 1, wherein said annular tubular container has a cross-section that is at least one of a circular, elliptical, oval, or polygonal in shape.

3. The apparatus of claim 1, wherein the cross sectional areas of the portion of the container containing the fluid varies such that the liquid volume within one half of the annular tubular container is less than the liquid volume of the other half of the annular tubular container.

4. A vehicle comprising an apparatus forming a first functional unit that is attachable to a vehicle for producing vehicular motion, said apparatus comprising:
An annular tubular container having a varying cross-sectional area along the circumference of said tube;
A fluid filling said container;
A pump for circulating said fluid in said container, wherein circulation of said fluid by said pump creates thrust to produce vehicular motion.

5. The vehicle of claim 4, wherein said annular tubular container has a cross-section that is at least one of a circular, oval, elliptical, or polygonal in shape.

6. The vehicle of claim 4, wherein the cross sectional areas of the portion of the container containing the fluid varies such that the liquid volume within one half of the annular tubular container is less than the liquid volume of a different half of annular tubular container.

7. The vehicle of claim 4 further comprising having a mirror image of said apparatus attached to the same vehicle such that both annular tubular containers lie in the same plane such that the liquid in one annular tubular container circulates in a clockwise direction and the liquid in the other annular tubular container circulates in a counterclockwise direction thereby eliminating any spin to the vehicle.

8. The vehicle of claim 4 further comprising a plurality of pairs of functional units oriented in differing directions within a single plane to enable up to 4 degrees of freedom on a solid or liquid surface.

9. The vehicle of claim 4 further comprising a plurality of pairs of functional units wherein said plurality of pairs of functional units are oriented in both differing directions and intersecting planes to enable up to 6 degrees of freedom within a fluid or in the vacuum of space.

10. The vehicle in claim 4, wherein the individual functional units can temporarily operate at different rates in circulating their respective fluids such that the vehicle's attitude is changed in a controlled manner.

11. A method of producing vehicular motion comprising the steps of:
Providing annular tubular containers having a varying cross-sectional area along the circumference of said containers;
Providing a fluid for filling said containers;
Providing pumps for circulating said fluids in said containers;
Pumping said fluids to circulate the fluids to create thrust to produce vehicular motion.

12. The method of claim 11, wherein said fluid is pumped through its annular tubular container having a cross-section that is at least one of a circular, oval, elliptical, or polygon shape.

13. The method of claim 11, wherein said fluid is pumped through an annular tubular container and the cross-sectional areas of the portion of the container containing the fluid varies such that the liquid volume within one half of the annular tubular container is less than the liquid volume of a different half of the annular tubular container.

14. The method of claim 11 further comprising providing a second annular tubular containers, wherein the two annular tubular containers are attached to the same vehicle such that both annular tubular containers lie in the same plane such that the liquid in one annular tubular container circulates in a clockwise direction and the liquid in the other annular tubular container circulates in a counterclockwise direction thereby eliminating any spin to the vehicle.

15. The method of claim 11 further comprising a plurality of pairs of annular tubular containers oriented in differing directions within a single plane to enable a plurality of degrees of freedom on a solid or liquid surface.

16. The method of claim 11 further comprising a plurality of pairs of annular tubular containers wherein said plurality of pairs of functional units are oriented in both differing directions and intersecting planes to enable up to 6 degrees of freedom within a fluid or in the vacuum of space.

17. The method in claim 4, wherein the pumps can temporarily operate at different rates in circulating their respective fluids in their respective annular tubular containers such that the vehicle's attitude is changed in a controlled manner.
